(19) United States
(12) Patent Application Publication
(10) Pub. No.: US 2005/0015462 A1
(43) Pub. Date: Jan. 20, 2005

(54) Service gateway system and method of using the same

(75) Inventors: Sung-Jin Lee, Sungnam-si (KR); Sang-do Park, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/794,415

(22) Filed: Mar. 8, 2004

(30) Foreign Application Priority Data
Mar. 7, 2003 (KR) 2003-14275

(51) Int. Cl. G06F 17/30

(52) U.S. Cl. 709/217; 707/10

(57) ABSTRACT

Disclosed are a service gateway system and a method of using the same. The service gateway system includes a client agent and a service proxy. The client agent is capable of communicating with an external network, receives information on new services provided by service providers through the external network, updates a service bundle catalogue reflecting the received information, and shows the updated service bundle catalogue. The service proxy pushes an alarm message on the update of the service bundle catalogue and the updated service bundle catalogue to a registered home appliance so that a user may select the service for use through the home appliance. According to the above configuration, the user becomes aware of the arrival of the new service bundle in real time and selectively requests the new services for use.

### CROSS-REFERENCE TO RELATED APPLICATIONS

This application claims the priority of Korean Patent Application No. 2003-14275, filed Mar. 7, 2003, in the Korean Intellectual Property Office, the disclosure of which is incorporated herein by reference.

### BACKGROUND OF THE INVENTION

1. Field of the Invention

Apparatuses and methods consistent with the present invention relate to a service gateway system and a method thereof, and more specifically, to a service gateway system notifying a user of a new service bundle to be delivered in a form complying with the Open Services Gateway initiative (OSGi) interface standard to a home appliance in real-time so as to enable the user to selectively request the use of a new service, and to a method thereof.

2. Description of the Related Art

The primary goal of the Open Services Gateway initiative (OSGi) specification is to use the JAVA programming language's platform independence and the network mobility of the executable code so as to provide dynamic services for small-memory devices. The central component of OSGi specification effort is a service gateway that functions as a platform for many communication based services.

The service gateway enables, consolidates, and manages voice, data, Internet, and multimedia communications to and from a home, office and other locations. Also, the service gateway functions as an application server for a range of high value services such as energy management and control, safety and security services, and device control as well as provides a focal point for service providers to deliver services to client devices on a local network.

FIG. 1 is a diagram illustrating a process of delivering the new service bundle from a remote server 20 to a service gateway 40 in the OSGi interface standard-compliant form.

Referring to FIG. 1, real services 10a through 10n indicate real service providers, and a remote server 20 generates and distributes a service bundle corresponding to the services the service providers provide. For instance, if a pizzeria is one of the real services 10a-10n, the remote server 20 generates and distributes the service bundle corresponding to a pizza order.

The remote server 20 and the service gateway 40 access each other through an external network 30. The remote server 20 delivers the service bundle generated compliant with the OSGi interface standard to the service gateway 40.

However, the conventional service gateway 40 does not have a display device. Therefore, the user is not aware of in real time whether the new bundle which is compliant with the OSGi standard has been delivered from the remote server 20 or not. Also, the user is not able to view the delivered service bundle and not able to selectively request services for use.

In a roundabout way, an electronic mail (e-mail) can be used to inform the user, who uses the service gateway 40, of a delivery of the new service bundle. However, the e-mail is incapable of real-time processing as well as raises burdensome management of response e-mails from the user. Accordingly, in this way, both the user and the service provider experience inconvenience and inefficiency.

Therefore, a new approach is required which enables the user to be aware of information on the delivered new service bundle in the service gateway and to selectively request available services for use.

### SUMMARY OF THE INVENTION

Accordingly, it is an aspect of the present invention is to provide a service gateway system and a method of using the same so as to deliver information on a new service bundle received from a remote server to a user in real time and for the user to view the service bundle and to selectively request the new service for use.

To accomplish the above aspect, the service gateway system comprises a client agent capable of communicating with an external network, receiving information on new services provided by service providers through the external network, updating a service bundle catalogue with reflecting the received information, and showing the updated service bundle catalogue, and a service proxy pushing an alarm message about the update of the service bundle catalogue and the updated service bundle catalogue to a registered home appliance so that the user may select the service for use through the home appliance. The service bundle is generated by the remote server connected to the external network and is delivered in an Open Service Gateway initiative (OSGi)-compliant form.

The home appliance receives the available service bundle catalogue and transmits a response signal to the service proxy, and the service proxy delivers the response signal to the client agent so as to request the use of the new service to the remote server.

The home appliance includes a display device and the alarm message is displayed on the display device through a pop-up window. The service proxy uses a push technology for pushing the alarm message and the service bundle catalogue in sequence.

The service proxy may comprise an update checking unit for examining whether the service bundle catalogue is updated or not, a registration authenticating unit for registering and authenticating the home appliance, a message processing unit for transmitting the response signal from the home appliance to the client agent, a JAVA code processing unit for generating and transmitting JAVA bytecodes to the home appliance, with the JAVA bytecodes enabling download of information through the push technology, and a push server unit for pushing information to the home appliance by means of the push technology.

A method of using the service gateway system comprises the steps of (a) receiving information on the new services provided by the service providers from the remote server connected to the external network, (b) updating the service bundle catalogue with reflecting the received information and showing a list of available service bundles, and (c) registering the home appliance having the display device and delivering an alarm message on an update of the service bundle and the service bundle catalogue to the home appliance so that the new services are selected for use through the home appliance. In the step (a), the service bundle is transmitted in an Open Services Gateway initiative (OSGi)-compliant form.

The method further comprises the steps of receiving a response signal of requesting a use of the new services from the home appliance, and sending the response signal to the remote server and requesting the new services.

In the step (c), the alarm message is displayed on the display device of the home appliance through the pop-up window. The alarm message and the service bundle catalogue are sequentially delivered to the home appliance by means of the push technology.

The step (c) comprises the steps of generating JAVA bytecodes for receiving information by means of the push technology, and transmitting the JAVA bytecodes to the home appliance.

### BRIEF DESCRIPTION OF THE DRAWINGS

The above described aspects and features of the present invention will be clarified by describing an exemplary embodiment in detail with the accompanying drawings:

FIG. 1 is a diagram illustrating how a service bundle is delivered from a remote server to a service gateway;

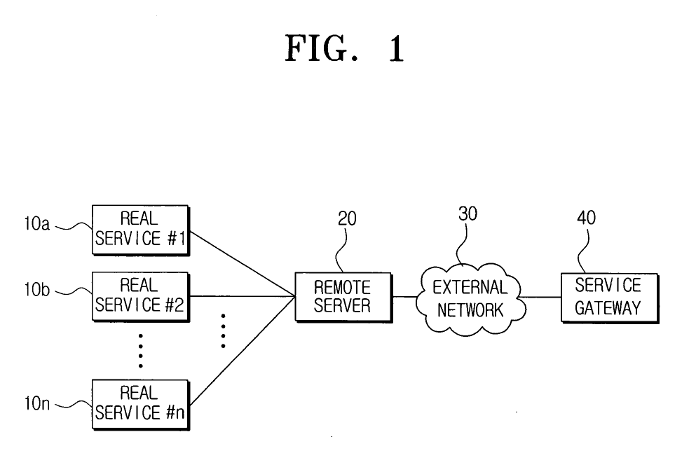

FIG. 2 is a diagram illustrating a service gateway system according to an embodiment of the present invention;

FIG. 3 is a diagram illustrating a configuration of the service gateway of FIG. 2;

FIG. 4 is a diagram illustrating a configuration of a service proxy of FIG. 3;

FIG. 5 is a flow chart illustrating processes of the service gateway system according to the present invention;

FIGS. 6 through 8 are examples illustrating operations of the service gateway system according to the present invention; and

FIG. 9 is a message sequence chart schematically illustrating data transmitted between the service gateway and a home appliance.

### DETAILED DESCRIPTION OF THE EXEMPLARY EMBODIMENT

Hereinafter, the present invention will be described in more detail with reference to the accompanying drawings.

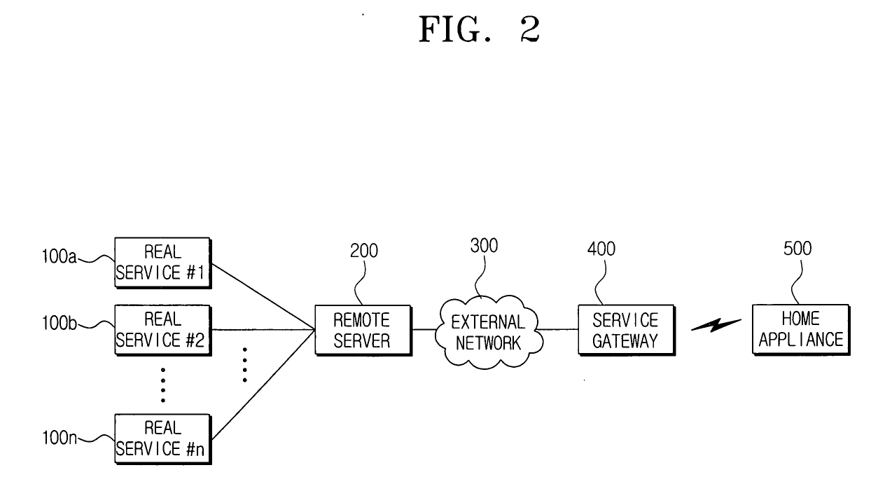

FIG. 2 is a diagram showing a service gateway system according to an embodiment of the present invention. Referring to FIG. 2, real services 100a-100n indicate real service providers and a remote server 200 generates and distributes a service bundle corresponding to the real services of the real service providers.

The remote server 200 and the service gateway 400 access each other through an external network 300. The remove server 200 transmits the service bundle generated in compliance with the Open Services Gateway initiative (OSGi) standard to the service gateway 400.

A home appliance 500 includes a display device, and accesses the service gateway 400 through a registration and an authentication. The service gateway 400 generates a service bundle catalogue showing a list of an available service bundle, and updates the service bundle catalogue reflecting a new service bundle available. When the service bundle catalogue is updated, the service gateway 400 pushes an alarm message about update and the updated service bundle catalogue, to the home appliance 500. The user views the service bundle catalogue in the home appliance 500 and determines whether to use the services or not.

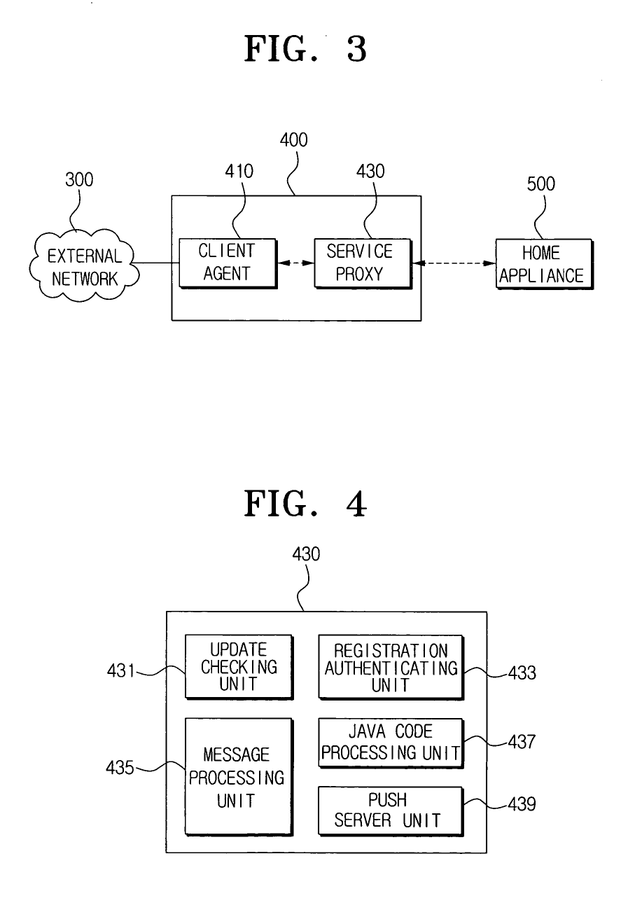

FIG. 3 is a diagram showing a configuration of the service gateway 400 of FIG. 2. Referring to FIG. 3, the service gateway 400 comprises a client agent 410 and a service proxy 430.

The client agent 410 receives information on the new service from the remote server 200 and updates the service bundle catalogue reflecting the new service bundle. The client agent 410 can also communicate with other devices which are connected to the external network 300 and can be operated in association with the remote server 200. When the client agent 410 updates the service bundle catalogue, the service proxy 430 pushes the alarm message about the update and the updated service bundle catalogue to the home appliance 500. The user notices the alarm message in the home appliance 500 so as to become aware of the new services available. Accordingly, the user views the service bundle catalogue and selects the new services for use. That is, information on the new service bundle, which has been conventionally delivered from the remote server 200 to the client agent 410, is delivered further to the home appliance 500 which is in the same area as the user.

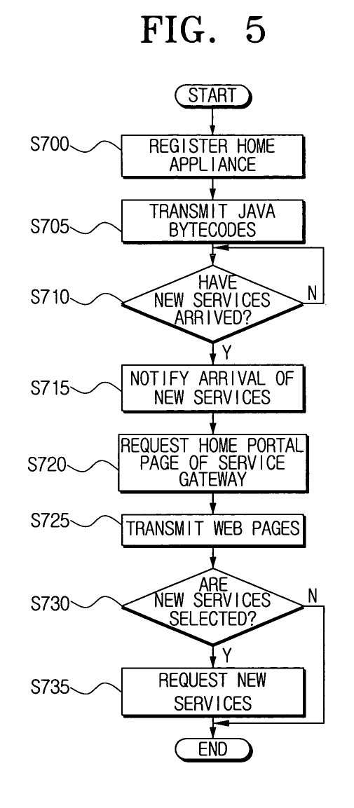

FIG. 4 is a diagram showing a configuration of the service proxy 430 of FIG. 3. Referring to FIG. 4, the service proxy 430 comprises an update checking unit 431, a registration authenticating unit 433, a message processing unit 435, JAVA code processing unit 437, and push server unit 439.

The update checking unit 431 periodically examines whether the service bundle catalogue is updated by the client agent 410. The registration authenticating unit 433 is responsible for registration and authentication of the home appliance 500 having the display device. The message processing unit 435 delivers a selection of the user with respect to the new service bundle from the home appliance 500 to the client agent 410.

The JAVA code processing unit 437 generates JAVA bytecodes which are platform-independent and transmits the JAVA bytecodes to the home appliance 500 which has been registered and authenticated. The JAVA bytecodes are a result of compiling a file including JAVA source language sentences, i.e., a compiled JAVA code. The JAVA bytecodes transmitted to the home appliance 500 are executed so that information is pushed to the home appliance 500.

The push server unit 439 uses a push service for the home appliance 500. The push service is the delivery of information on the Web that is initiated by a server rather than by a user.

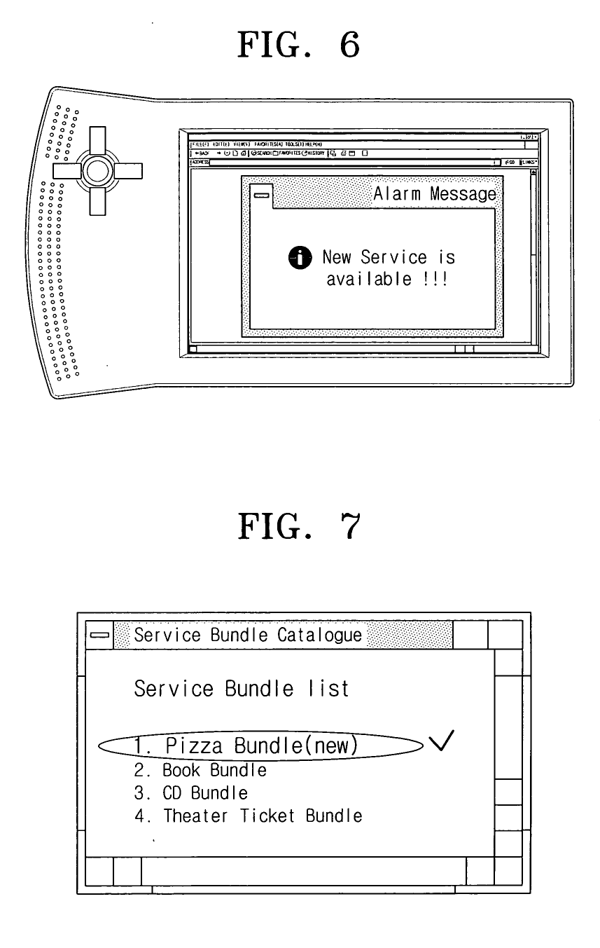

FIG. 5 is a flow chart illustrating processes of the service gateway system according to the present invention.

Referring FIG. 5, the home appliance 500 including the display device is registered to the service gateway 400 (S700). The registration and the authentication of the home appliance 500 are conducted by the registration and authenticating unit 433 in the service proxy 430.

When the registration and the authentication of the home appliance 500 are completed, the service gateway 400 transmits the platform-independent JAVA bytecodes to the home appliance (S705). The home appliance 500 downloads and installs the JAVA bytecodes and executes a JAVA applet to get ready to act as a client for the push service.

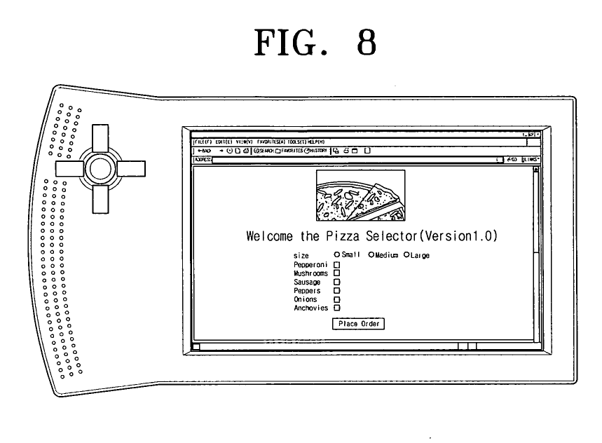

The update checking unit 431 periodically examines whether the service bundle catalogue is updated by the client agent 410 or not when new services are generated in the remote server 200 (S710). According to a result of the examination, that is, when the service bundle catalogue is updated due to the generation of new services, the service proxy 430 pushes the alarm message on the update of the service bundle catalogue so as to notify the user of an arrival of the new services (S715). The alarm message is displayed on the display device of the home appliance 500 through a pop-up window. FIG. 6 shows an example of the alarm message in the pop-up window of the display device of the home appliance 500. The pop-up window is a small window that suddenly appears in a foreground of a graphical user interface (GUI).

In wishing to view the updated service bundle catalogue, the user requests a home portal page of the service gateway (S720). Next, the service gateway transmits the home portal page to the home appliance 500 to show the updated service bundle catalogue (S725).

FIG. 7 is an example of the service bundle catalogue. In FIG. 7, there are available service bundles such as ‘Pizza Bundle’, ‘Book Bundle’, ‘CD Bundle’, and ‘Theater Ticket Bundle’, with the ‘Pizza Bundle’ marked as a new service bundle. The user views the above service bundle catalogue and may request a service with respect to the new service bundle. When the user requests the new service, the client agent 410 requests the new service to the remote server 200. Otherwise, i.e., when the user does not request the new service, the operation is ended without the request for the new service (S730, S735).

FIG. 8 shows an example of a screen displayed on the display device of the home appliance 500 when the user selects and requests the ‘Pizza Bundle’. The user views the screen and actually orders a desired pizza.

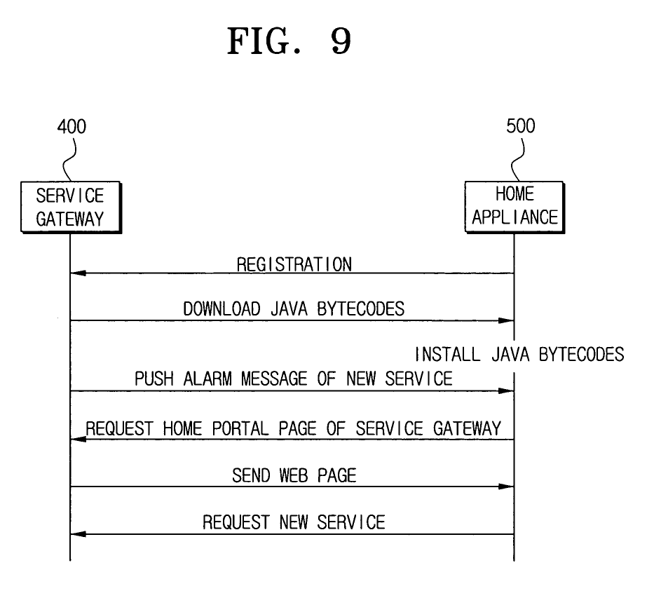

FIG. 9 is a message sequence chart schematically illustrating data transmitted between the service gateway 400 and the home appliance 500.

As aforementioned, the home appliance 500 is registered to the service gateway 400, and the service gateway 400 transmits the JAVA bytecodes to the registered home appliance 500 for download and installation. When the service bundle catalogue is updated due to the generation of new services, the service gateway 400 pushes the alarm message on the arrival of the new services to the home appliance 500. Accordingly, when the user requests the updated service bundle catalogue through the home appliance 500, the home appliance 500 requests the home portal page of the service gateway 400. Next, the service gateway 400 sends the Web page to show the updated service bundle catalogue. The user views the updated service bundle catalogue, and if necessary, requests the new service for use.

According to the above processes, the service bundle, which has been conventionally delivered from the remote server 200 to the client agent 410 of the service gateway 300, is delivered in real time further to the home appliance 500 for providing a notice to the user. The user views the screen on the display device of the home appliance 500 and may select the new services for use.

As aforementioned, according to the present invention, information on the new service bundle to be transmitted from the remote server is delivered in real time to the home appliance having the display device. The user is notified of the arrival of the new services and is able to selectively utilize the available services. Therefore, for the user as well as for the service providers, convenience is enhanced and services are provided efficiently.

While the exemplary embodiment of the present invention has been described, additional variations and modifications in that embodiment may occur to those skilled in the art once they learn of the basic inventive concepts. Therefore, it is intended that the appended claims shall be construed to include both the preferred embodiment and all such variations and modifications as fall within the spirit and scope of the invention.

1. A service gateway system comprising:
a client agent communicating with an external network, the client agent receiving information on at least one of new services provided by service providers through the external network, updating a catalogue of available services reflecting the information, in an update, and showing an updated catalogue; and
a service proxy sending a message about the update of the catalogue and the updated catalogue to a device.

2. The service gateway system of claim 1, wherein the catalog is a service bundle catalog and a service bundle is generated by a remote server connected to the external network and is delivered in an Open Service Gateway initiative (OSGi)-compliant form.

3. The service gateway system of claim 1, wherein the device receives the updated catalogue and transmits a response signal to the service proxy, and the service proxy delivers the response signal to the client agent to request a use of at least one of the new services to the remote server.

4. The service gateway system of claim 3, wherein the device comprises a display device and the message is displayed on the display device through a pop-up window.

5. The service gateway system of claim 4, wherein the service proxy uses a push technology for pushing the message and the updated catalogue in a sequence.

6. The service gateway system of claim 5, wherein the service proxy comprises:
an update checking unit for examining whether the catalogue is updated or not;
a registration authenticating unit for registering and authenticating the device;
a message processing unit for transmitting the response signal from the device to the client agent;
a JAVA code processing unit for generating and transmitting JAVA bytecodes to the device, the JAVA bytecodes enabling a download of the information through the push technology; and
a push server unit for pushing the information to the device through the push technology.

7. A method of using a service gateway system comprising:
(a) receiving information on at least one of new services provided by service providers from a remote server connected to an external network;
(b) updating a catalogue of available services reflecting the information and showing an updated catalogue; and
(c) registering a device having a display device and delivering a message on an update of a service bundle and the catalogue to the device.

8. The method of claim 7, wherein, in receiving the information, the service bundle is transmitted in an Open Services Gateway initiative (OSGi)-compliant form.

9. The method of claim 7, further comprising:
receiving a response signal of requesting a use of the at least one of the new services from the device; and
sending the response signal to the remote server and requesting the at least one of the new services.

10. The method of claim 9, wherein, in delivering the message, the message is displayed on the display device of the device through a pop-up window.

11. The method of claim 10, wherein, in delivering the message, the message and the updated catalogue are sequentially delivered to the device by means of a push technology.

12. The method of claim 11, wherein delivering the message comprises:
generating JAVA bytecodes for receiving the information by means of the push technology; and
transmitting the JAVA bytecodes to the device.

13. The service gateway system of claim 1, wherein the device is a home appliance.

14. The service gateway system of claim 1, wherein the message is an alarm message.

15. The service gateway system of claim 1, wherein the service proxy pushes the message and the updated catalogue.

16. The service gateway system of claim 1, wherein a user selects one of the at least one of the new services from the updated catalogue through the device.

17. The method of claim 7, wherein the device is a home appliance.

18. The method of claim 7, wherein the message is an alarm message.

19. The method of claim 7 further comprising selecting one of the at least one of the new services through the device.
